(19) United States
(12) Patent Application Publication
(10) Pub. No.: US 2020/0154672 A1
(43) Pub. Date: May 21, 2020

(54) Method for training a dog and a training set

(71) Applicant: Susanna Paavilainen, Mäntsälä (FI)

(72) Inventor: Susanna Paavilainen, Mäntsälä (FI)

(21) Appl. No.: 16/335,320

(22) PCT Filed: Sep. 23, 2016
(86) PCT No.: PCT/FI2016/050663

§ 371 Date: Mar. 21, 2019

(51) Int. Cl. A01K 15/02; G09B 19/00; G06F 16/9038

(52) U.S. Cl. CPC A01K 15/02; G06F 16/9038; G09B 19/00

(57) ABSTRACT

According to an example aspect of the present invention, there is provided a system comprising a set of cans comprising at least two cans of which one can contains a specific scent, each can including a tab providing a dog a means to express choosing of the can, and transmitter for transmitting the information of whether the dog has expressed the can with the specific scent or a can with no said specific scent and an apparatus comprising at least one processing core, at least one memory including computer program code, the at least one memory and the computer program code being configured to, with the at least one processing core, cause the apparatus at least to store the transferred information of multiple expressions, process the stored information in order to calculate at least how many of the multiple expression are correct, and display the results of the processed data.

### FIELD

The invention relates to a method for training a dog to indicate a specific scent. The method can be used for training pet dogs as a hobby or working dogs for training and subsequently certifying the level of performance of a trained dog. The invention also relates to a training set including tools and equipment for utilizing the method.

### BACKGROUND

The sense of smell is the strongest and most accurate sense of dogs. A dog communicates with scents and receives information of the environment on basis of different scents. A medium sized dog has about 220 million olfactory receptors, a cat about 200 million and a human only 5 million. A dog can sense more than 2000 different scents. This ability has been used by humans for different purposes such as hunting, tracking or finding and indicating various substances as long as humans and dogs have lived together. Today dogs are used to detect mould, drugs and explosives, for example, as well as finding lost persons or people in collapsed buildings.

There are no specified methods for training a dog to find or indicate scents. Every dog trainer has his or hers own training methods. Because of this abilities of different dog/trainer pair vary and there is not method for effectively comparing the effectiveness or capabilities of different dogs or dog/trainer pairs. Evaluation is very subjective. For these reasons it is difficult to say how reliable a classification or indication performance of a single dog is.

### SUMMARY OF THE INVENTION

The invention is defined by the features of the independent claims. Some specific embodiments are defined in the dependent claims.

According to a first aspect of the present invention, there is provided method for training a dog, comprising teaching a dog to express a reaction to a specific scent and thereafter training the dog to express the specific scent from at least two different samples. The dog is lead to express the specific scent from the at least two samples and the information of which sample the dog has expressed is transferred to an apparatus comprising at least one processing core, at least one memory including computer program code, the at least one memory and the computer program code being configured to, with the at least one processing core, cause the apparatus at least to: store the transferred information of multiple expressions, process the stored information in order to calculate at least how many of the multiple expression are correct, and display the results of the processed data. Places of at least two samples are changed and expression and storing of the result are repeated. The changing of places of the samples and subsequent expression is continued to provide a series of experiments.

According to a second aspect of the present invention, there is provided a system comprising:
a set of cans comprising at least two cans of which one can contains a specific scent, each can being associated with a pad providing a dog a means to express choosing of the can, and transmitter for transmitting the information of whether the dog has expressed the can with the specific scent or a can with no said specific scent; and
an apparatus comprising at least one processing core, at least one memory including computer program code, the at least one memory and the computer program code being configured to, with the at least one processing core, cause the apparatus at least to:
store the transferred information of multiple expressions,
process the stored information in order to calculate at least how many of the multiple expression are correct, and
display the results of the processed data.

According to one aspect of the invention the system comprises a program for controlling the reception of the information from the set of cans, storage of the transferred information and processing or making a request to process the stored information and display of the processed information.

According to one aspect of the invention the program is installed to a cell phone.

According to one aspect of the invention, the set of cans comprises one can with a specific scent and at least one can from a group including: a can with no scent and a can with a different scent to the specific scent.

According to one aspect of the invention, the cans of the set have a similar appearance so that they can't be visually distinguished from each other and at least the can with a specific scent has a non-visual indicator communicating with the pad to inform that this can contains the specific scent.

### BRIEF DESCRIPTION OF THE DRAWINGS

FIGS. 1A-1C illustrate a general application of the method and system in accordance with at least some embodiments of the present invention;

FIGS. 2, 3, 4, 5 and 6 illustrate example apparatuses capable of supporting at least some embodiments of the present invention, and

FIG. 7 illustrates an example apparatus capable of supporting at least some embodiments of the present invention.

### EMBODIMENTS

### Definitions

In the present context, the term “can” comprises any container that has a storage space that can be made to release a scent to environment when desired.

A pad is a device that sends a signal when touched.

The invention relates to teaching and practicing dogs to detect and express specific scents. Further, the invention relates to practices to study performance of a dog in detecting a specific scent and further to qualifying and certifying the performance of a dog for various purposes. Features of the invention include a set of cans provided with a can with the specific scent the dog is trained to express and dummy or empty cans. Each can has an indicator for communicating whether the can contains the specific scent or is a dummy. Information processing software and hardware is provided for storing and handling the data of series of experiments and training sessions of a dog to provide helpful information for further training and/or qualifying and certifying purposes. Various embodiments of the invention provide a large scale of applications for working with a dog as a hobby or for professional purposes.

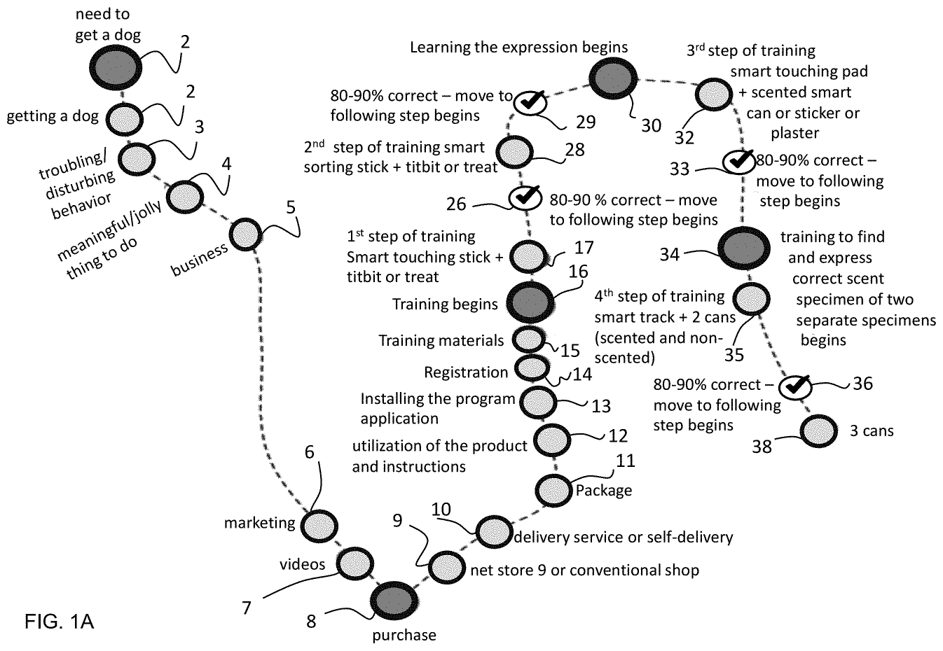

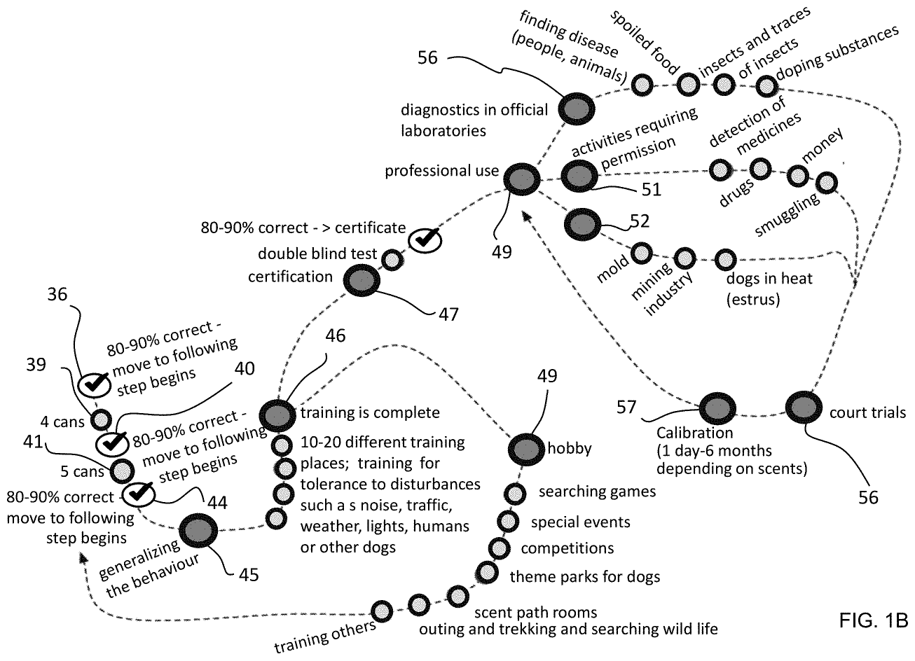

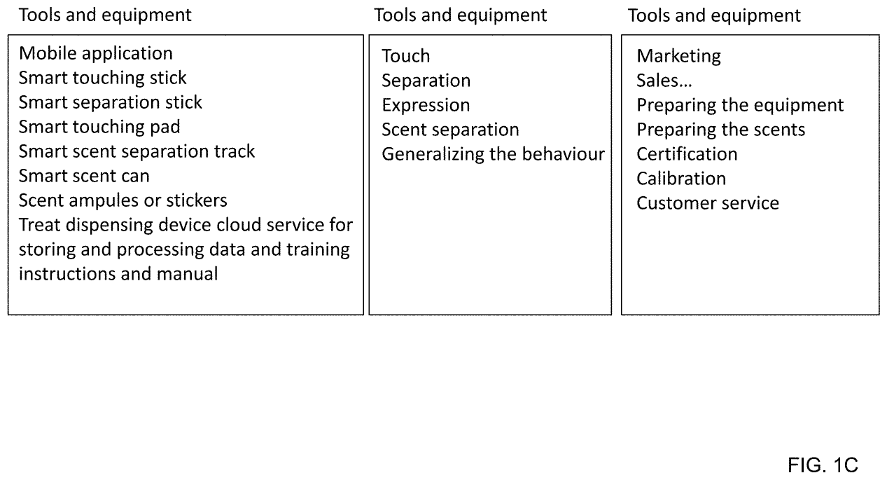

FIG. 1 illustrates various activities relating to the invention and in accordance with at least some embodiments of the present invention. This chart shows how the invention and its embodiments can relate to all aspects of dog ownership.

Everything begins with a need 1 to get a dog, either a family pet or a working dog. Thereafter follows obtaining 2 the dog on basis of needs and desires of an individual or family. Every dog needs interaction with other dogs or humans to be happy and training to act as a functional part of a human environment where it lives. Absence of such interaction may lead to trouble behaviour 3. Often trouble behaviour of dogs can be traced to inadequate activity. The dog maybe is let alone for a day and only walked short time during the day and otherwise it is let unnoticed. As all dogs need physical and mental activities every day, too little interaction and exercise may make a dog feel neglected and start a troubling or disturbing behaviour. This phenomenon naturally brings out a need to find some meaningful and jolly thing to do 4 and spend time with the dog.

The above mentioned need initiates a slot for a business opportunity 5. The embodiments of the invention utilize this opportunity. They provide various ways to combine elements of the invention to activity, hobby or training packages that can be promoted by marketing 6. The marketing materials may include videos introducing the products to customers and to educate different range of possibilities the embodiments of the invention provide. If a customer, or in this case dog owner, is interested of promoted activity, the person purchases 8 a product package that best suits need of the person and the dog. The chosen product may be purchased from a net store 9 or conventional shop 9 and delivered 10 to the customer of or the customer may take the product with him- or herself. The product is a package 11 including instructions, physical elements and programs or applications needed for using the product. The utilization 12 of the product begins with familiarizing to instructions provided and installing a program application to a suitable device, preferably on a cell phone but possibly to a tablet, a laptop or any such device. the application may be included in the package or obtainable from an external source such a s a cloud service. Registration 14 as a user may be provided for obtaining training materials and instructions and for obtaining further features such as communication with other dog owners using similar products, for analysing results of training and to get support to solve problems as well as hints for varying or enhancing the training. When necessary preparations are done, training 16 may begin.

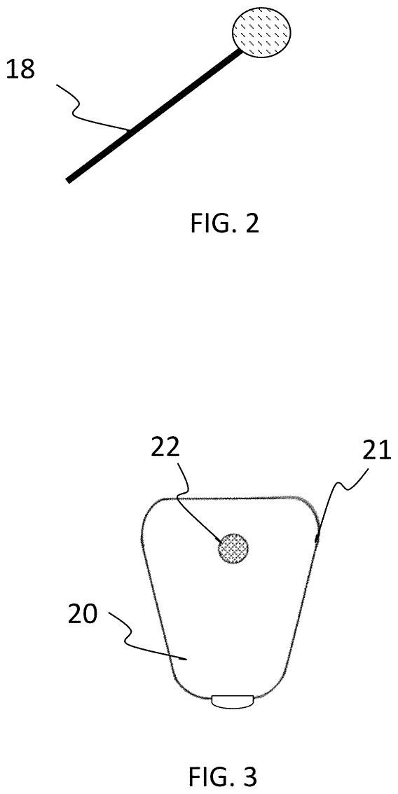

In one embodiment first step of training 17 is to teach the dog to touch an object on command. This can be practiced by using a touching stick illustrated in FIG. 2. The stick comprises a rod-like handle 18 and a touch ball 19 in one end of the handle 18. The ball 19 comprises elements for sensing a command given by the trainer of the dog, sensing a touch to the ball and for sending information that a touch has occurred to suitable application, for example on a cell phone. The touching stick 18, 19 is combined with a clicker 20 illustrated in FIG. 3. The clicker comprises a push button 21 for giving a sound signal to the dog to do the trained action, in this case to touch the touch ball 19. The command is communicated by communicating elements to the touch ball 19 so that only touches made after given command are accepted. Commands are also sent to the application in the phone. Now the application has information of how many attempts have been made and how many of them have been successful. The clicker has also a press button 22 for making a sound for affirming the behaviour of the dog. Suitable titbits or treats are usually used as a reward of a desired behaviour. A training package may include such treats and a dispenser for disposing the treats. The supreme software application used calculates automatically the course of the training and success rate 26. When the dog can perform this exercise correctly about 80-90% of tries, the pair of trainer and dog can move to following step to a more difficult exercise. The clicker 20 may be realized by an application in a smart phone. As a phone inherently includes communication transmitter and receiver as well as a memory and either a touch pad or keyboard, the functions of the clicker 20 can be easily implemented as a suitable application. Such a clicker may include tailored elements and functions and can be customized to users needs.

Next exercise 28 is training with a sorting stick 23, preferably using treats. This differs from the touching stick 18, 19 so that it has a touch ball 14, 25 in each end of the handle 18. The touch balls include same detection and communication elements as the touch ball of the touching stick. The sorting stick may include a switch for choosing which one of the touch balls 24, 25 is the one that the dog is supposed to touch. The touch balls 24, 25 of the sorting stick 23 have different colours, they may be, for example, black and white. When training with the sorting stick 23, the trainer chooses which one of the touch balls 24, 25 the dog is supposed to touch, gives a command and the sorting stick communicates with the application software whether the expression of the dog has been correct one. As previously, when a success rate 29 of 80-90% is achieved, the pair may proceed to next level.

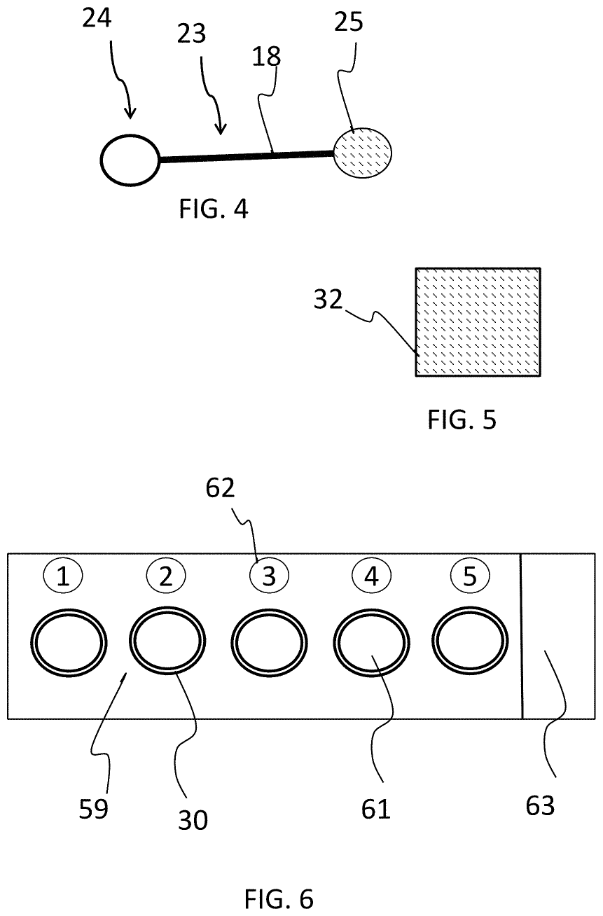

At this level 30 the training for a scent is begun. First step 32 in here is training with a pad 31 illustrated schematically in FIG. 5. The pad 31 has a surface for touching with nose or paw and similar communication and detection means as the touch balls for indicating a touch and communicating the result (correct/incorrect) of the touch to an application. The dog may be trained simply touch the pad 31 at this stage and/or touch the pad when it is scented with a desired scent. The pad may be associated with a can having the desired scent or a scented sticker or a plaster, for example. Again, when success rate 33 of 80-90% is achieved, the pair may proceed to next level.

At this level 34 the dog is trained to find and express a correct scent specimen of two separate specimens. From this stage 35 on, a training track is used. One embodiment of a training track includes at least two cans, one of which includes a specific scent the dog is supposed to find and indicate. The can may include a scent specimen readily installed or ampules, stickers or other devices containing a scent that can be placed within the can may be used. The can may be closed or closable by closing elements such as lids, stickers or like so they can be stored and made ready for use by removing the closing element.

The number of cans with no scent is increased when the training proceeds. Each can is associated with a pad 31. The dog is supposed to find the scented can and indicate it on command by the trainer. The trainer may know which one of the cans is the correct one and indicate the correct expression by clicking the button 22 for the affirmative sound of the clicker 20. In this case the clicker 20 transmits the result to the application processing the results. This method is not double blind. If a double blind training results are needed, at least the can containing the scent must include a non-visual indicator that informs the pad that this particular can contains the scent. The indicator may be a RFID chip, other data chip or simply a magnet that sets the pad to send a signal that correct expression has been made. The data transferred can be very simple as basically only digital yes/no information is needed to show whether a correct expression has been made. When the success rate 36 of 80-90% is achieved, the pair moves to a next level 37, wherein one more non-scented can is added and the number of choices the dog has is three. This training phase is continued until a success rate of 80-90% is achieved for 5 cans. One possibility to further increase the performance level is to use a set of can containing one specific scent that is being detected and one or more can containing other various scents.

The next step 45 is generalizing the behaviour. Now training is continued in 10-20 different places in order to learn tolerance to disturbances such a s noise, traffic, weather, lights, humans or other dogs. After this stage the training is complete when the success rate remains in the same level as obtained in previous stages. If necessary, the pair may return to a previous stage from any level if the present level seems to be too difficult.

Now the dog/trainer pair can proceed to two different paths. The activity can be continued as a hobby 48. This route provides several possibilities, for example participation in searching games, special events, competitions or theme parks for dogs, scent path rooms, outing and trekking as well as searching wild food like mushroom, berries or other wild plants. The professional route leads to certification 47 of the performance of the dog. In this stage 47 a double blind trials are needed. Such trials can be performed on a scent track described above. In here it is preferable that the cans can communicate presence of the specific scent to the system without the trainer knowing of the communication. Alternatively the scent track may be set up when the trainer and the dog are absent and performing each expression when the person who has set up the track is absent.

In professional route the dog may proceed to diagnostics 56 in official laboratories. In these laboratories a trained dog can be used for detecting medical samples and finding diseases such as cancer and diabetes, spoiled food, insects and traces of insects, doping substances and traces of them and many others. Other activities 51 requiring permission include detection of medicines, drugs, money and other objects or substances that are prone to smuggling. Unregulated working possibilities 52 include detection of mould, in mining industry and detecting heat (estrus) in other dogs or other animals, for example. The possibilities of using the sense of smell of dogs is rather limitless and the embodiments of the invention provide efficient way to improve reliability and repeatability of the detection by the dog. This is essential to achieving high confidence level for the performance of the trained dog. If a high enough confidence level is achieved, trained dogs can be used effective even in diagnostics and court trials 58 without further confirmation by other methods.

If the dog is used in above described tasks, calibration 57 of the performance level is needed. The calibration interval is dependent of the type of scent and possibly of government regulations.

The devices used for implementing the various embodiments of the invention include a mobile application for a smart phone/cell phone, a smart touching stick, a smart separation stick, a smart scent separation track, a smart scent can, scent ampules or stickers, a treat dispensing device, a cloud service for storing and processing data and training instructions and manual. Training methods include touch, separation, expression, scent separation and generalizing the behaviour. Services and processes may include marketing and sales, manufacture of devices, manufacture of scents, certification services, calibration services and customer service. Even a social network services for users can be provided. Some examples of the above mentioned devices are described above. Is to be understood that these are only illustrative examples and may be varied in structure and operation.

FIG. 6 illustrates a smart separation track. The track comprises a frame 59 with five holes 60 for scent cans 61. Each hole is associated with a numbered tab 62. The tab 62 may be a pressure pad, a switch or any such device capable of transmitting a signal when touched. At the end of the track is an automatic treat dispenser 63. The track may be operated manually so that each can is placed in a hole 60 by user. Alternatively the device can be automated so that relative locations of cans 16 and holes can be changed. The openings may be provided with lids that can be automatically opened and closed. Such a track can be circular so that locations of the holes in relation to cans can be altered easily by rotation. The track may include an array of multiple holes so that, for example five holes can be opened at one time and other holes can be closed. Such an automated track can be used independently without a human user when dog is alone, for example at home during a work day. The track device is then activated at desired intervals, for example at every hour or every second hour. When the device is activated, a number of holes 60 are opened. One of the holes includes a scent that dog should express. When the dog expresses the correct hole 60 by pressing a tab 62, it gets a treat from dispenser 63. Thereafter the track changes the location of the scent or a new set of openings is opened making the dog to work for a minute or any desired time. Then the track is switched off and started again after a set interval. In this way the dog can be entertained during the day when they are home alone. As the dog has a meaningful task to do, troublesome behaviour can be avoided or at least reduced.

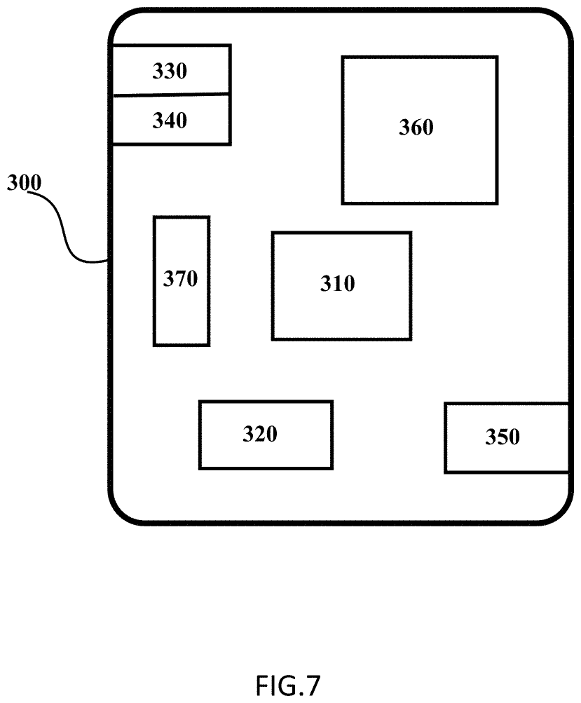

FIG. 7 illustrates an example apparatus capable of supporting at least some embodiments of the present invention. Illustrated is device 300, which may comprise, for example, a mobile communication device such as mobile. Comprised in device 300 is processor 310, which may comprise, for example, a single- or multi-core processor wherein a single-core processor comprises one processing core and a multi-core processor comprises more than one processing core. Processor 310 may comprise more than one processor. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 7. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in field of training dogs and evaluating their performance.

1. A system comprising:
a set of cans comprising at least two cans of which one can contains a specific scent, each can including a tab providing a dog a means to express choosing of the can, and transmitter for transmitting the information of whether the dog has expressed the can with the specific scent or a can with no said specific scent; and
an apparatus comprising at least one processing core, at least one memory including computer program code, the at least one memory and the computer program code being configured to, with the at least one processing core, cause the apparatus at least to:
store the transferred information of multiple expressions,
process the stored information in order to calculate at least how many of the multiple expression are correct, and
display the results of the processed data.

2. The system according to the claim 1, further comprising a program for controlling the reception of the information from the set of cans, storage of the transferred information and processing or making a request to process the stored information and display of the processed information.

3. The system according to the claim 2, wherein the program is installed to a cell phone.

4. The system according to claim 1, wherein the set of cans comprises one can with a specific scent and at least one can from a group including: a can with no scent and a can with a different scent to the specific scent.

5. The system according to claim 1, wherein the cans of the set have a similar appearance so that they can't be visually distinguished from each other and at least the can with a specific scent has a non-visual indicator communicating with the pad to inform that this can contains the specific scent.

6. The system according to claim 1, further comprising a clicker for giving a sound signal to a dog to perform a task and for giving a another sound signal indicating correctly conducted performance.

7. The system according to claim 6, wherein the clicker includes a transmitter for transmitting a signal indicating that a sound signal for performing a task is given, and preferably a receiver for receiving indication of that a task is correctly performed.

8. The system according to claim 5, wherein the clicker is a cell phone including an application for implementing the functions of the clicker.

9. The system according to claim 1, wherein the data is stored and processed in a cloud service.

10. The system according to claim 1, wherein the data is stored and processed in a local device such as a smart phone, tablet or a computer.

11. A method for training a dog, comprising:
teaching a dog to express a reaction to a specific scent;
training the dog to express the specific scent from at least two different samples,
leading the dog to express the specific scent from the at least two samples,
transferring information of which sample the dog has expressed to an apparatus comprising at least one processing core, at least one memory including computer program code, the at least one memory and the computer program code being configured to, with the at least one processing core, cause the apparatus at least to:
store the transferred information of multiple expressions,
process the stored information in order to calculate at least how many of the multiple expression are correct, and
display the results of the processed data,
changing places of at least two samples and subsequently repeating expression and storing of the result, and
repeating the changing of places of the samples and subsequent expression to provide a series of experiments.

12. The method according to the claim 11, further comprising a set of sample cans for providing the series of experiments, the set comprising:
at least one can containing specific scent;
at least one can containing different scent,
means for detecting the expression of the dog, and
means for providing data whether the expression is correct or not.

13. The method according to claim 12, wherein the cans of the set have a similar appearance so that they can't be visually distinguished from each other and at least the can with a specific scent has a non-visual indicator communicating with the pad to inform that this can contains the specific scent.

14. The method according to claim 11, further comprising giving a sound signal to a dog to perform a task and for giving a another sound signal indicating correctly conducted performance.

15. The method according to the claim 14, further comprising transmitting a signal indicating that a sound signal for performing a task is given, and preferably a receiver for receiving indication of that a task is correctly performed.

16. The method according to claim 11, wherein the data is stored and processed in a cloud service.

17. The method according to claim 11, wherein the data is stored and processed in a local device such as a smart phone, tablet or a computer.

18. A non-transitory computer readable medium having stored thereon a set of computer readable instructions that, when executed by at least one processor, cause an apparatus to at least:
store the transferred information of multiple expressions obtained by leading a dog to express a specific scent from a at least two samples;
process the stored information in order to calculate at least how many of the multiple expression are correct, and
display the results of the processed data.

19. A non-transitory computer readable medium configured to cause a method for training a dog to be performed, the method comprising:
teaching a dog to express a reaction to a specific scent,
training the dog to express the specific scent from at least two different samples,
leading the dog to express the specific scent from the at least two samples,
transferring information of which sample the dog has expressed to an apparatus comprising at least one processing core, at least one memory including computer program code, the at least one memory and the computer program code being configured to, with the at least one processing core, cause the apparatus at least to:
store the transferred information of multiple expressions,
process the stored information in order to calculate at least how many of the multiple expression are correct, and
display the results of the processed data,
changing places of at least two samples and subsequently repeating expression and storing of the result, and
repeating the changing of places of the samples and subsequent expression to provide a series of experiments.
